(19) United States
(12) Patent Application Publication
(10) Pub. No.: US 2016/0220995 A1
(43) Pub. Date: Aug. 4, 2016

(54) MICROFLUIDIC SYSTEMS WITH MICROCHANNELS AND A METHOD OF MAKING THE SAME

(71) Applicant: WESTERN MICHIGAN UNIVERSITY RESEARCH FOUNDATION, Kalamazoo, MI (US)

(72) Inventors: Massood Zandi Atashbar, Portage, MI (US); Binu Baby Narakathu, Portage, MI (US)

(21) Appl. No.: 14/917,837

(22) PCT Filed: Sep. 11, 2014
(86) PCT No.: PCT/US2014/055183

§ 371 Date: Mar. 9, 2016

Related U.S. Application Data
(60) Provisional application No. 61/876,820, filed on Sep. 12, 2013.

(51) Int. Cl. B01L 3/00; B29C 33/38

(52) U.S. Cl. CPC B01L 3/502707; B01L 3/502715; B29C 33/3842; B01L 2300/0645; B01L 2300/123; B01L 2300/161; B01L 2200/12; B33Y 10/00

(57) ABSTRACT

A flexible microfluidic device, including a first substrate having micro-rough microchannels therein, a second substrate having electrodes thereon, and a bonding layer securing the second substrate to the first substrate. Alternatively, one or more bonding surfaces of the first and second substrate are treated to increase bonding activity, and are bonded together. To manufacture the device, a microchannel mold is formed and placed in a mold cavity to create a master mold. A curable polymeric material is added to the mold cavity and cured to form the first substrate. Electrodes are printed on the second substrate. A bonding layer is coated on the first or second substrate, the substrates are aligned, and the bonding layer is cured. Alternatively, the bonding surfaces of the first and/or second substrate are subjected to treatment to increase bonding activity, the substrates are aligned, and permitted to bond.

### RELATED APPLICATION

This application claims priority under 35 U.S.C. §119(e) to U.S. Provisional Patent Application No. 61/876,820, filed Sep. 12, 2013, entitled “MICROFLUIDIC SYSTEMS WITH MICROCHANNELS AND A METHOD OF MAKING THE SAME,” which is herein incorporated by reference in its entirety.

### BACKGROUND OF THE INVENTION

The present concept relates generally to a microfluidic system having microchannels and electrodes, and to a method of manufacturing the same.

### BRIEF SUMMARY OF THE INVENTION

In one aspect, the present disclosure includes a flexible microfluidic device, having a first substrate with micro-rough microchannels formed in a first surface of the first substrate and a second substrate having conductive electrodes disposed on a second surface of the second substrate. A bonding layer of curable polymeric material secures the second substrate to the first substrate.

In another aspect, the present disclosure includes a flexible microfluidic device, having a first substrate with micro-rough channels formed on a first surface thereof. A second substrate has conductive electrodes disposed on a second surface thereof. At least one of the first bonding surface and the second bonding surface is treated to form a treated surface. The treated surface has an increased bonding activity as compared to the treated surface before it was treated.

In another aspect, the present disclosure includes a method of manufacturing a master mold for a microfluidic device. The method includes the steps of forming a microchannel mold with raised lines extending generally orthogonally from a top surface of the microchannel mold, wherein the raised lines are formed using at least one of PCB manufacturing methods and additive printing methods. The microchannel mold is positioned in a mold cavity to form the master mold.

In yet another aspect, the present disclosure includes a method of manufacturing a microfluidic device, the method including the steps of forming a microchannel mold having a bottom surface and a top surface, and having raised lines extending generally orthogonally from the top surface. The microchannel mold is positioned within a mold cavity of a block, with the bottom surface of the microchannel mold supported by the block to create a master mold. A first substrate material is added to the master mold and cured to form a first substrate having a first surface with microchannels formed therein. Electrodes are printed on a second surface of a second substrate. A bonding layer is applied to at least one of the first surface of the first substrate and the second surface of the second substrate. The first substrate and the second substrate are positioned to align the electrodes with the microchannels with the bonding layer between the first substrate and the second substrate. The bonding layer is cured.

In yet another aspect, the present disclosure includes a method of manufacturing a microfluidic device including the steps of forming a microchannel mold having a bottom surface and a top surface and raised lines extending generally orthogonally from the top surface. The microchannel mold is positioned within a mold cavity of a block, with the bottom surface of the microchannel mold supported by the block to create a master mold. A first substrate material is added to the master mold and cured to form a first substrate with microchannels formed in a first surface thereof. Electrodes are printed on a second surface of a second substrate. At least one of the first surface of the first substrate and the second surface of the second substrate is treated to increase bonding activity. The microchannels of the first substrate and the electrodes of the second substrate are aligned and the first surface is allowed to bond with the second surface.

These and other features, advantages, and objects of the present invention will be further understood and appreciated by those skilled in the art by reference to the following specification, claims, and appended drawings.

### BRIEF DESCRIPTION OF THE DRAWINGS

FIG. 1A is a cross sectional view of a microfluidic device having microchannels formed therein and a bonding layer;

FIG. 1B is a cross sectional view of another embodiment of a microfluidic device having microchannels formed therein;

FIG. 2 is a top view of a first substrate for a microfluidic device having microchannels formed therein;

FIG. 3 is a top view of a second substrate for a microfluidic device, with electrodes provided thereon;

FIG. 3A is an enlargement of the electrode shown in FIG. 3;

FIG. 4 is a top view of a master mold for forming microchannels in the substrate shown in FIGS. 1A and 1B;

FIG. 5 is a schematic of a microchannel mold for a master mold as shown in FIG. 4 designed using PCB software;

FIG. 6 is a top perspective view of a block for use in a master mold as shown in FIG. 4;

FIG. 7 is a side view of the master mold shown in FIG. 4;

FIG. 8 is a top perspective cutaway view of a microchannel;

FIG. 9 is a schematic of an experimental setup using a microfluidic device having a substrate with microchannels and electrodes; and

FIG. 10 is a graph illustrating the electrochemical response of the microfluidic device experimental setup shown in FIG. 8.

### DETAILED DESCRIPTION

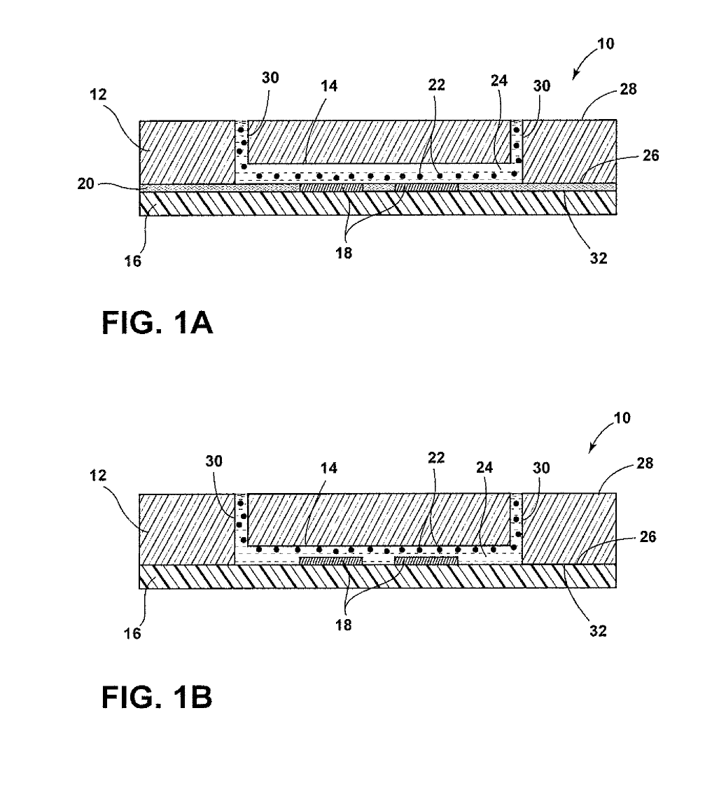

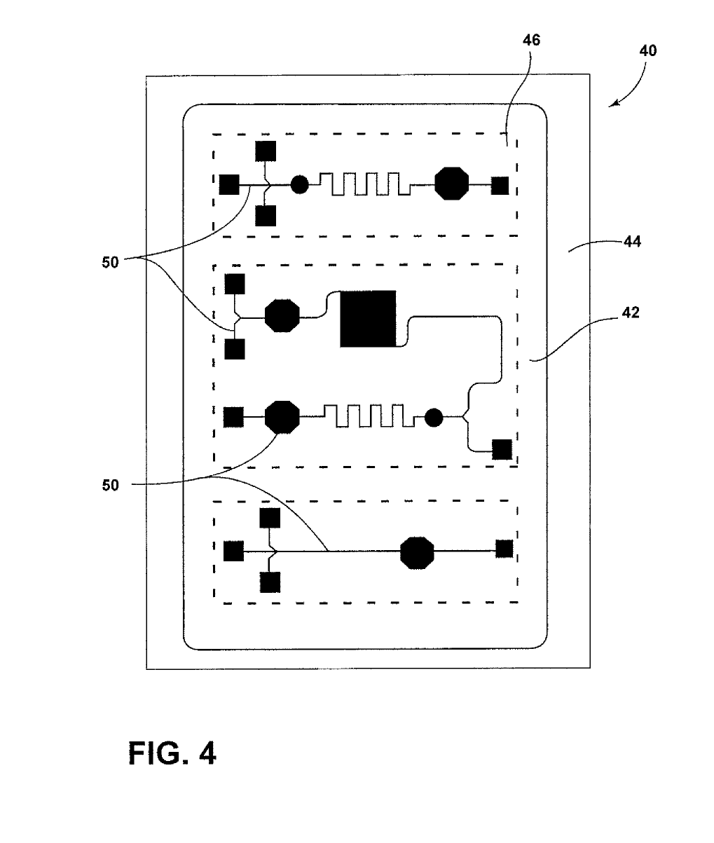

For purposes of description herein, the terms “upper,” “lower,” “right,” “left,” “rear,” “front,” “vertical,” “horizontal,” and derivatives thereof shall relate to the concept as oriented in FIGS. 1A and 1B (and FIG. 4, as applicable). However, it is to be understood that the concept may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As shown in the embodiment depicted in FIG. 1A, the present concept generally includes a flexible microfluidic device 10 which includes a first substrate 12 having at least one microchannel 14 formed therein, and a second substrate 16 having electrodes 18 provided thereon. The second substrate 16 is bonded to the first substrate 12, with the electrodes 18 facing the first substrate 12, by applying a bonding layer 20 to the first substrate 12, the second substrate 16, or both the first and second substrates 12, 16, and positioning the first and second substrates 12, 16 with respect to each other prior to the bonding layer 20 being cured. The microfluidic device 10 described herein can be used, for example, as a sensor to detect analytes 22 in a fluid 24, including dissolved or suspended analytes 22.

As shown in the embodiment depicted in FIG. 1B, the present concept generally includes the flexible microfluidic device 10 which includes the first substrate 12 having at least one microchannel 14 formed therein. The microchannels 14 are formed in a first surface 26 of the first substrate 12, and an opposing surface 28 of the first substrate 12 preferably includes inlet and/or outlet ports 30 to permit the fluid 24 to be supplied to the microchannels 14. The second substrate 16 has electrodes 18 disposed on a second surface 32 of the second substrate 16. The second substrate 16 is bonded to the first substrate 12, with the electrodes 18 facing the first substrate 12, by treating the first surface 26 of the first substrate 12, the second surface 32 of the second substrate 16, or both, to modify and activate the surface(s) 26, 32 for bonding, and then aligning the surfaces 26, 32 and allowing them to bond to form the microfluidic device 10. The microfluidic device 10 described herein can be used, for example, as a sensor to detect analytes 22 in the fluid 24, including dissolved or suspended analytes 22.

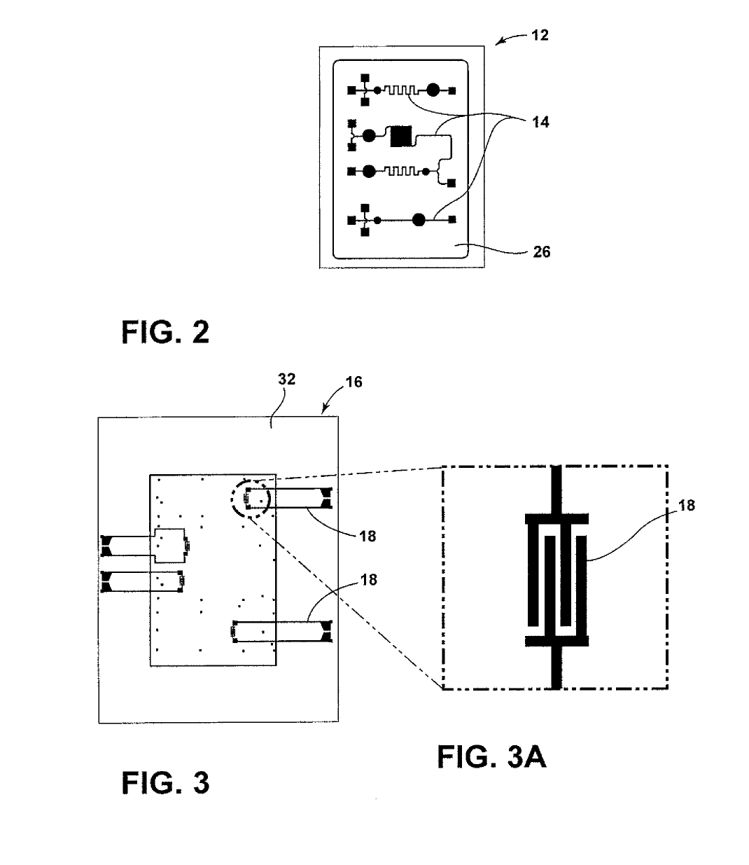

As shown in the embodiments depicted in FIGS. 1A, 1B, and 2, the first substrate 12 is generally planar, with the first surface 26 and the opposing second surface 28. Microchannels 14 are sized to permit the passage of very small amounts of the fluid 24 to be analyzed. “Microchannels” as used herein includes all fluid passageways on the first substrate 12, including without limitation reservoirs, mixing channels and chambers, separation junctions, addition junctions, reaction chambers and channels. The inlet and/or outlet ports 30 are also formed in the first substrate 12, to permit the fluid 24 to be supplied to the microchannels 14 from a fluid source (not shown) through the opposing surface 28 of the first substrate 12. The first substrate 12 is generally made from a curable polymeric material, which has a liquid or flowable consistency prior to curing, and a flexible, though solid consistency after curing.

The second substrate 16, as shown in the embodiments depicted in FIGS. 1A-1B and 3-3A, is a thin film with a generally planar shape, and has electrodes 18 on a second surface 32 thereof. The second substrate 16 is bonded to the first substrate 12, with the second surface 32 of the second substrate 16 (having the electrodes 18 thereon) facing the first surface 26 of the first substrate 12 (having the microchannels 14 formed therein). The electrodes 18 align with and interact with the microchannels 14 to allow the application of electrical signals to the fluid 24 in the microchannels 14.

In the embodiment depicted in FIG. 1A, the second substrate 16 is bonded to the first substrate 12 using a coated adhesive bonding layer 20, such as a curable polymeric material, which is optionally the same material that is used to make the first substrate 12. Acrylates, polyester resins, and laminate films are additional non-limiting examples of curable materials that can act as the bonding layer 20. After coating the adhesive bonding layer 20, the first substrate 12 and second substrate 16 are aligned and the bonding layer 20 is permitted to cure. In the embodiment depicted in FIG. 1B, the second substrate 16 is bonded to the first substrate 12 by treating one or both surfaces 26, 32 to modify and activate the surfaces 26, 32 for bonding. Exemplary treatments include, without limitation, treating with a silane coating, including 3-aminopropyl triethoxysilane; treating with solvents, including alcohols, acetone, DMSO, and acetonitrile; treating with acids; treating with heat; treating with plasma energy; treating with UV/ozone; and treating with a corona discharge. Such treatments promote the bonding of the surfaces 26, 32 to each other. Optionally, one or both surfaces 26, 32 can act as an adhesive surface by partial curing or cross-linker variation of the first or second substrates 12, 16. After treatment, the first surface 26 of the first substrate 12 and the second surface 32 of the second substrate are aligned, and then pressed together and allowed to bond to form a microfluidic device 10. In another embodiment, after treatment to activate one or both of the surfaces 26, 32, one or both of the surfaces 26, 32 can be coated with an adhesive bonding layer 20. The first substrate 12 and second substrate 16 are then aligned and the bonding layer is permitted to cure.

To design and fabricate the microfluidic system 10, a master mold 40, as shown in the embodiments depicted in FIGS. 4 and 7, is used to form the first substrate 12. As shown in FIG. 4, the master mold 40 preferably includes two parts, a microchannel mold 42 and a block 44. As best shown in the embodiment depicted in FIG. 7, the microchannel mold 42 has a top surface 46 and an opposing bottom surface 48, with raised copper lines 50 extending generally orthogonally upward from the top surface 46. Although the lines 50 are referred to herein as “raised copper lines” it is understood that the lines can comprise any material which can be etched using PCB manufacturing technology or deposited using additive printing methods, like gravure, screen or inkjet printing.

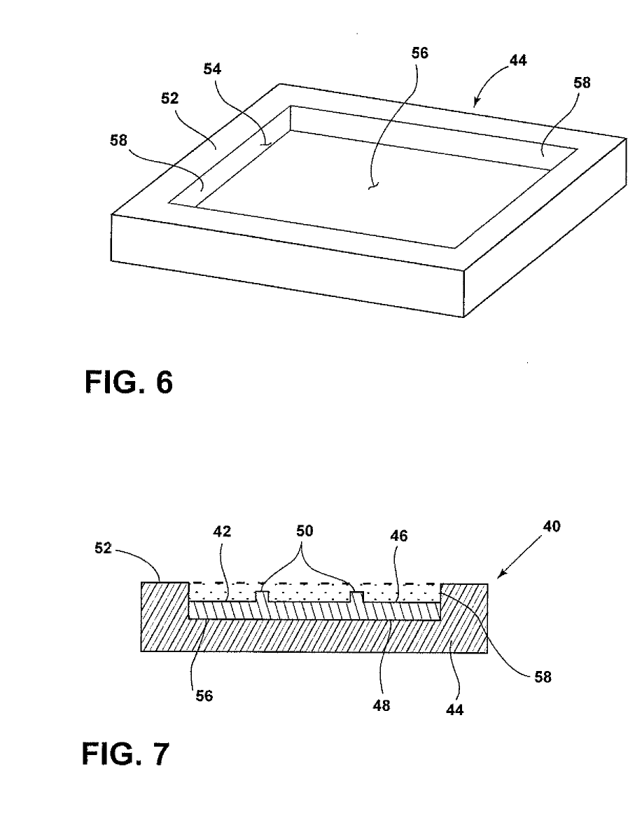

The block 44, one embodiment of which is shown in FIG. 6, has a top surface 52 with a mold cavity 54 formed therein. The mold cavity 54 has a generally flat bottom surface 56 and side walls 58 extending upwardly from the flat bottom surface 56 to define a perimeter of the mold cavity 54. To assemble the master mold 40, the microchannel mold 42 is placed along the flat bottom surface 56 of the mold cavity 54, with the raised copper lines 50 extending upwardly into the mold cavity 54.

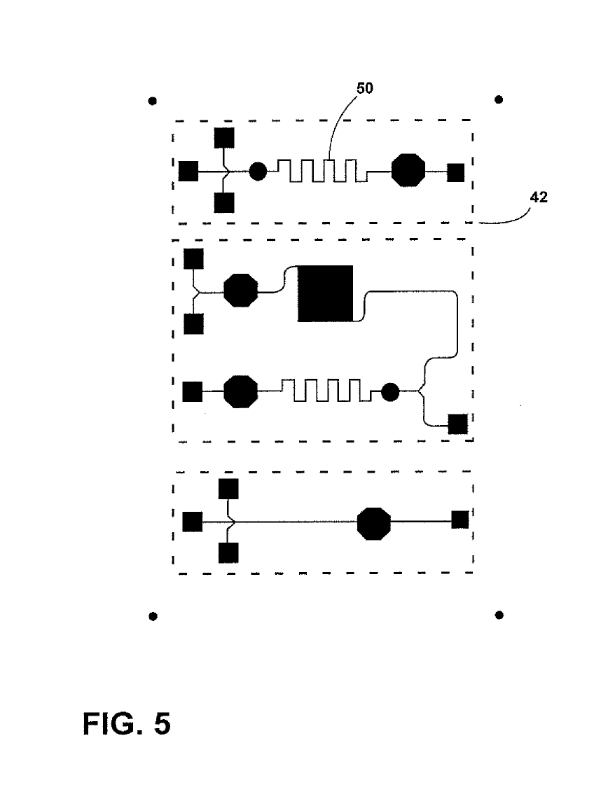

As shown in the embodiment depicted in FIG. 5, traditional printed circuit board (“PCB”) design and manufacturing methods can be used to design and implement the pattern of raised copper lines 50 on the top surface 46 of the microchannel mold 42, and therefore the corresponding microchannels 14 on the first surface 26 of the first substrate 12. For example, software such as ExpressPCB™ software can be used to design the desired layout of raised copper lines 50 on the microchannel mold 42. The raised copper lines 50 are then created using known PCB manufacturing methods, whereby a copper sheet is deposited on the top surface 46 of the microchannel mold 42, and is then masked and etched to create the raised copper lines 50. The raised copper lines 50 created in this way have micro-rough areas at both sides of the copper lines 50 that become smooth as the edges of the copper lines 50 taper to the top surface 46 of the microchannel mold 42. The raised copper lines 50 are used in the master mold 40 to form the micro-rough microchannels 14 in the first substrate 12 as further described below.

Additive printing methods, including gravure, screen, or inkjet printing, could also be used in place of PCB manufacturing methods to create micro-rough, raised copper lines 50 on the microchannel mold 42 to form micro-rough microchannels 14 in the first substrate 12 as further described herein.

As best shown in the embodiment depicted in FIGS. 6-7, the microchannel mold 42 is placed within the mold cavity 54 of the block 44 to create the master mold 40. The mold cavity 54 is of a size and shape to receive the microchannel mold 42, with the bottom surface 48 of the microchannel mold 42 supported by the flat bottom surface 56. The block 44 provides rigidity and structure to the master mold 40, and provides support for the microchannel mold 42, as well as defining side walls 58 for the master mold 40 to contain material used to form the first substrate 12 of the microfluidic device 10. The material used for the block 44 can include any material which provides sufficient structure and rigidity to the master mold 40 over the temperature range that the master mold 40 is intended to be used. Preferable materials also permit the release of the material used to form the first substrate 12 after formation. Non-limiting examples of suitable materials include plastic resins, wood, or metal, with any of the foregoing having an optional coating to provide desired characteristics, such as release of the first substrate 12 material.

To form the first substrate 12, a curable polymeric material is added to the master mold 40 in its liquid or flowable state and is then cured, to form the flexible first substrate 12. The raised copper lines 50 form indentations on the first side of the first substrate 12, which are the microchannels 14 on the first substrate 12. Following curing, the first substrate 12 is removed from the master mold 40, and inlet and/or outlet ports 30 for the fluid 24 are cored out of the first substrate 12. Suitable tools for forming the inlet and/or outlet ports 30 for the microchannels 14 include biopsy punch tools, or other tools capable of making small-scale holes in the flexible solidified material of the first substrate 12.

Suitable materials for making the first substrate 12 generally include polymeric materials, such as PDMS, polymethylmethacrylate (PMMS), polycarbonate, polyepoxide, cyclic olefin polymers (COP), cyclic olefin copolymers (COC), or other materials suitable for making a flexible microfluidic device 10, so long as the materials used for the first substrate 12 can be formed using the mold 40 described herein (e.g., the material is curable and is able to conform to the master mold 40 at a temperature that does not melt the master mold 40 material).

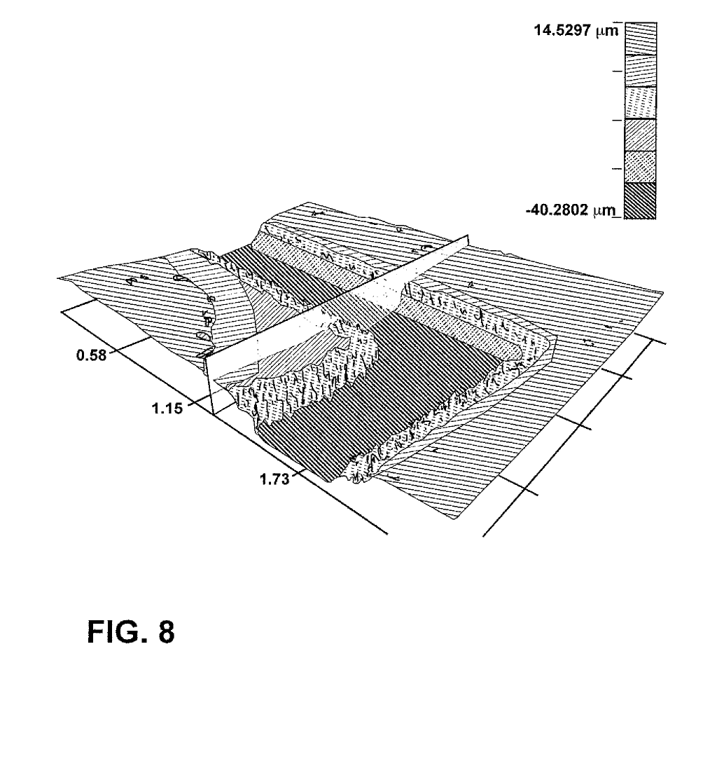

As shown in the embodiment depicted in FIG. 8, the microchannels 14 formed in the first side 26 of the first substrate 12 have micro-roughened edges as a result of the raised copper lines 50. The 3-dimensional topography of the microchannels 14, as shown in FIG. 8, was visualized and measured by vertical scanning interferometry, using a Bruker Contour GTL EN 61010 laser profilometer (Bruker Biosciences Corporation, USA), with Bruker Vision software operating in hybrid mode. In this embodiment, the depth of the microchannel 14 was found to be 55 μm.

The second substrate 16 is a thin film, including without limitation a polymeric film or a PET film, or polymeric materials such as PDMS, polymethyl-methacrylate (PMMS), polycarbonate, polyepoxide, cyclic olefin polymers (COP), cyclic olefin copolymers (COC), with electrodes 18 formed thereon, as shown in FIG. 3. To form the electrodes 18 a conductive ink is preferably printed onto the first surface 32 of the thin film second substrate 16 to form interdigitated electrodes 18, as shown in greater detail in FIG. 3A. Suitable printing methods for printing the electrodes 18 include inkjet printing, screen printing, gravure printing, or other methods capable of printing conductive inks.

To complete manufacture of the microfluidic device 10, the first substrate 12 having microchannels 14 formed therein and the second substrate 16 having electrodes 18 thereon are assembled to form the microfluidic device 10. In one embodiment, as shown in FIG. 1A, assembly of the first and second substrates 12, 16 includes masking the electrodes 18 on the second substrate 16 and coating a thin layer of curable liquid polymeric material on the first surface 32 of the second substrate 16 to form a bonding layer 20. The bonding layer 20 functions as an adhesive. Alternatively, assembly of the first and second substrates 12, 16 includes filling the microchannels 14 with a removable material, and coating a thin layer of curable liquid polymeric material on the first surface 26 of the first substrate 12 to form a bonding layer 20. Suitable removable materials include, without limitation, wax or ice, which are used to fill the microchannels 14. Coating methods such as bar coating, which provides a uniform coating, are preferred for applying the bonding layer 20 to the first substrate 12 or the second substrate 16, to ensure even and complete bonding between the first substrate 12 and the second substrate 16.

In another embodiment, as shown in FIG. 1B, the assembly of the first and second substrates 12, 16 includes treating the first and second substrates 12, 16 to promote bonding. Preferably, the first and second substrates 12, 16 are cleaned by placing the first and second substrates 12, 16 on a non-conducting surface with the first surface 26 of the first substrate 12 and second surface 32 of the second substrate 16 exposed. One non-limiting, exemplary cleaning agent is an isopropyl alcohol solution. One or both of the first surface 26 of the first substrate and the second surface 32 of the second substrate 16 are treated to promote bonding. For example, a corona discharge treatment can be performed on the surfaces 26, 32 by passing a corona discharge device over each of the surfaces 26, 32 in order to promote bonding. The treated surfaces 26, 32 are then pressed together and permitted to bond to form the microfluidic device 10 as shown in FIG. 1B. Alternate treatment methods, as described above, include without limitation: treating with a silane coating, including 3-aminopropyl triethoxysilane; treating with solvents, including alcohols, acetone, DMSO, and acetonitrile; treating with acids; treating with heat; treating with plasma energy; and treating with UV/ozone.

In yet another embodiment, to improve the bonding of the first and second substrates 12, 16, one or both surfaces 26, 32 can be treated to activate the surface 26, 32 for bonding before applying a bonding layer 20. The resulting microfluidic device 10 would generally have the structure as shown in FIG. 1A.

In one embodiment of the manufacture of a microfluidic device 10, the layout of the desired microchannels 14 is designed using ExpressPCB™ software. The PCB microchannel mold 42 is designed to have overall dimensions that correspond to the desired height and width of the first substrate 12. For example, in this embodiment, the microchannel mold 42 has overall dimensions of about 96.5 mm (height) by about 63.5 mm (width) by about 1.57 mm (thickness). The raised copper line thickness 50 of the microchannel mold 42 is set to about 55 μm. The PCB microchannel mold 42 is manufactured from traditional PCB materials, using traditional PCB manufacturing methods. PCB manufacturing methods create raised copper lines having micro-rough edges, by etching copper sheets on the non-conductive top surface 46 of the microchannel mold 42.

The PCB microchannel mold 42 is then placed into the mold cavity 54 in the block 44. One material that is suitable for use in manufacturing the block 44 is a Delrin® Acetal block. Such blocks can be purchased from McMaster-Carr® with dimensions of about 101.6 mm (height) by about 76.2 mm (width) by about 12.7 mm (thickness). The mold cavity 54 is formed by machining a cavity of the desired size and shape out of a top surface 52 of the block 44, in this example, a machined area of about 96.5 mm (height) by about 63.5 mm(width) by about 5 mm(depth) accommodates the microchannel mold 42 described above. In this particular embodiment, the side walls 58 of the block 44 extend upwards approximately 3.5 mm from the top surface 46 of the microchannel mold 42, defining the mold cavity 54 where the polymeric material can be poured.

The first substrate 12 is formed by filling the mold cavity 54 with a curable polymeric material, where the material is constrained by the side walls 58 of the mold cavity 54, and covers the top surface 46 of the microchannel mold 42 at a thickness sufficient to cover the raised copper lines 50. One material that can be used to form the first substrate 12 is polydimethylsiloxane (PDMS), which is sold as a two-part heat curable silicone elastomer kit (Sylgard® 184 from Dow Corning) including a pre-polymer and a curing agent. To use PDMS, the Sylgard® 184 pre-polymer and curing agent are combined in a 10:1 (w/w) ratio, and stirred vigorously until well mixed. Bubbles introduced by the mixing are removed by allowing the mixture to rest at room temperature for a sufficient length of time, such as 30 minutes. Alternative methods for removing air from the solution could also be employed. The PDMS is then poured into the master mold 40 described herein and cured at 90° C. for thirty (30) minutes in a VWR oven. Following curing, the PDMS can be peeled from the master mold 40, forming the first substrate 12. In the embodiment described herein, having raised copper lines 50 with a height of 55 μm, the average width and thickness of microchannels 14 formed in the first substrate 12 were measured to be about 500 μm and about 45 μm. Microchannels 14 having varying width or thickness can be created by using different patterns for formation of raised copper wires 50 on the PCB microchannel mold 42, and by use of an alternative method, like an additive printing method, for creating the microchannel mold 42. The printing technique can be chosen based on the desired height or depth of the microchannel, with different printing methods resulting in different thicknesses of the raised lines 50.

In an alternative embodiment, a microchannel mold 42 is created by producing a design layout of microchannels 14 with CoventorWare software. A stainless steel mesh pattern of the microchannels 14 was produced following the design layout and used for screen printing the microchannel mold 42 using a silver-based ink to print a microchannel mold 42 with overall dimensions of about 96.5 mm by 63.5 mm by 1.58 mm, with a raised line 50 thickness of about 10 μm. The microchannel mold 42 is placed in the corresponding mold cavity 54 in the block 44 to form a master mold 40. The microchannel mold 42 is used to form the first substrate 12, by adding a curable polymeric material to the master mold 40 in its liquid or flowable state to a depth sufficient to cover the raised lines 50, and then curing the polymeric material. The screen-printed microchannel mold 42 used in a master mold 40 produced a microfluidic device 10 that had micro-rough microchannels 14 having a depth of 9 μm.

Inlet and/or outlet ports 30 for the microchannels 14 are then formed in the first substrate 12, preferably using tools that can remove cores 30 having a diameter of about 1 mm. One example of such a tool is biopsy puncher model 33-31AA from Miltex®. Alternative tools can also be used to create inlet and/or outlet ports 30 communicating with the microchannels 14 in the first substrate 12.

Further, in this embodiment the second substrate 16 is formed on a flexible thin film, such as a polyethylene terephthalate (PET) film.

In one embodiment, conductive silver-based ink is printed onto the first surface of the thin film to form electrodes 18 using a Dimatix 2831 inkjet printer. In the embodiment shown in FIGS. 3 and 3A, two pairs of electrodes 18 are provided for each of a plurality of biosensors present on the microfluidic device 10. Each of the pairs of electrodes is 5.4 mm long, with a width of 200 μm and a spacing of 600 μm.

In one embodiment, the assembly of the first and second substrates 12, 16 includes the steps of masking the electrodes 18 on the second substrate 16, and bar-coating liquid PDMS onto the PET second substrate 16 to form a bonding layer 20 with a thickness of about 12.7 μm on the first surface 32 of the second substrate 16 as shown in FIG. 1A. The second substrate 16 is then positioned as desired with respect to the first substrate 12, and the bonding layer 20 is cured and solidified by heating the assembly in a VWR oven for 30 minutes at 90° C. to complete production of the microfluidic device 10 as shown in FIG. 1A.

In another embodiment, the assembly of the first and second substrates 12, 16 includes the steps of cleaning the first and second substrates 12, 16 and placing the first and second substrates 12, 16 on a non-conducting surface with the first surface 26 of the first substrate 12 and second surface 32 of the second substrate exposed. One non-limiting, exemplary cleaning agent is an isopropyl alcohol solution. A corona discharge treatment is performed on the surfaces 26, 32 by passing a corona discharge device over each of the surfaces 26, 32 at a height of about 6.4 mm above each of the surfaces 26, 32 for about 15 seconds, activating the surfaces 26, 32 for bonding. A suitable corona discharge device for providing the corona discharge treatment at the parameters described herein includes, without limitation, a laboratory corona treater (model BD-20AC, sold by Electro-Technic Products Inc.). The treated surfaces 26, 32 are then pressed together and permitted to bond by leaving undisturbed overnight to form the microfluidic device 10 as shown in FIG. 1B. Alternative corona discharge treatment protocols may be used to execute the corona discharge treatment step.

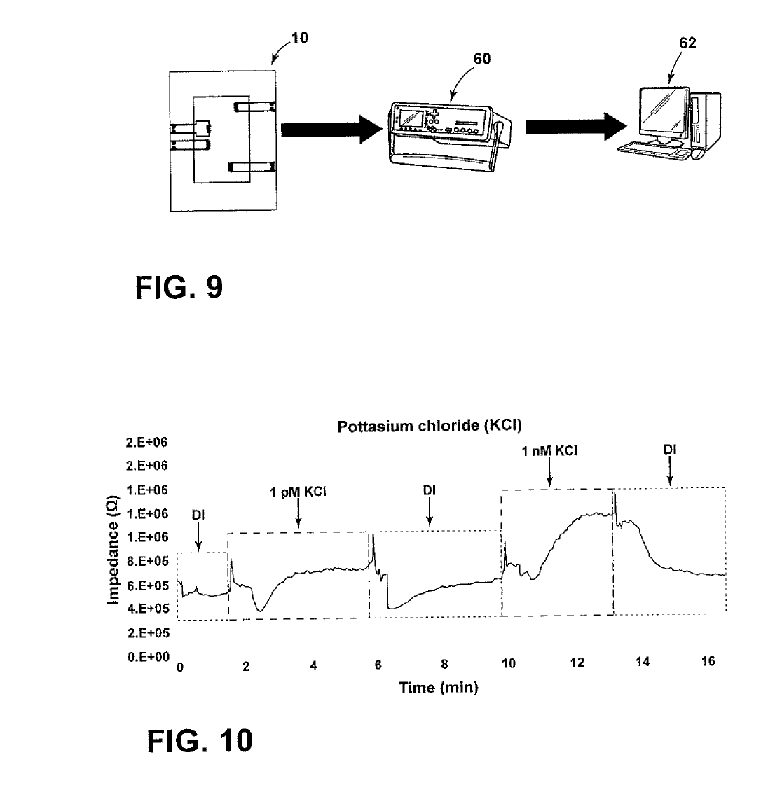

As illustrated in FIG. 9, to use one embodiment of a microfluidic device 10 as described herein, a programmable syringe pump (not shown) was connected to the inlet port 30 of the microchannel 14 for loading a test sample of fluid 24, such as a KDS210P syringe pump from KD Scientific. An LCR meter 60 was connected to the printed electrodes 18 via a test clip (not shown) to measure impedance. One example of a suitable LCR meter 60 is an Agilent model E4980A Precision LCR meter, and an example of a suitable test clip is a 5251 SOIC test clip from Pomona Electronics. Deionized water is loaded into the microfluidic device 10 to set a reference signal for the fluid 24, and then sample solutions with different concentrations (1 pM and 1 nM) of an analyte 22 such as potassium chloride were loaded into the microfluidic device 10. The impedance of the microfluidic device 10 was measured at a frequency of 1 kHz with a 1 mV voltage excitation. The response of the potentiostat was observed and analyzed on a PC 62 using a custom built LabView program.

As shown in FIG. 10, using the microfluidic device 10 described herein, the reference signal for the deionized water fluid 24 was established around 520 kΩ. Impedance measurements of around 700 kΩ and 1.1 MΩ were measured for the 1 pM and 1 nM concentration of KCl solution fluids 24, respectively. The microfluidic device 10 was shown to be reversible by introducing deionized water after each concentration of KCl solution was tested, as the impedance of the microfluidic device 10 returned to the base value of 520 kΩ. This response of the microfluidic device 10 demonstrated the capability of the microfluidic device 10 to distinguish among various concentrations of potassium chloride in a test sample of fluid 24.

Microfluidic devices 10 as described herein are capable of handling very low volumes of fluid 24 at a low cost per assay. The microfluidic devices 10 can be designed to carry out desired functions, such as cell separation, DNA sequencing, enzyme/substrate reaction systems, biosensors, and implanted drug delivery or metabolite analysis systems. These devices 10 are a promising way to realize an efficient, rapid response, portable, and cost effective approach to microfluidic applications. The microfluidic devices 10 and methods for manufacturing the devices 10 disclosed herein are also intended to be more cost effective and to have fewer barriers for preparation and manufacture than more traditional and expensive silicon mold based systems and conventional lithography techniques. This permits creation of inexpensive or disposable microfluidic devices 10 for mass market use, such as in multiple cancer marker analyses and on-site portable analytic systems, as non-limiting examples. It also allows further development and testing of the microfluidic devices 10, particularly by time-bound and/or budget-constricted non-experts. The microfluidic devices 10 and methods described herein also reduce the amount of material and energy wasted during fabrication of the devices 10.

It is also important to note that the construction and arrangement of the elements of the concept as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present concept. The exemplary structures and processes disclosed herein are for illustrative purposes and are not to be construed as limiting.

It is also to be understood that variations and modifications can be made on the aforementioned structures and methods without departing from the concepts of the present concept, and further it is to be understood that such concepts are intended to be covered by the following claims unless these claims by their language expressly state otherwise.

1. A flexible microfluidic device, comprising:
a first substrate having micro-rough microchannels formed in a first surface of the first substrate;
a second substrate having conductive electrodes disposed on a second surface of the second substrate; and
a bonding layer securing the second substrate to the first substrate, the bonding layer including a curable polymeric material.

2. The flexible microfluidic device of claim 1, wherein:
the first substrate is polydimethylsiloxane, polymethylmethacrylate, polycarbonate, polyepoxide, cyclic olefin polymer, or cyclic olefin copolymer.

3. The flexible microfluidic device of claim 1, wherein:
the second substrate is a polymeric film, PET film, polydimethylsiloxane, polymethylmethacrylate, polycarbonate, polyepoxide, cyclic olefin polymer, or cyclic olefin copolymer.

4. The flexible microfluidic device of claim 1, wherein:
the bonding layer is a curable polymeric material chosen from an acrylate, a polyester resin, or a laminate film.

5. The flexible microfluidic device of claim 1, wherein:
the microchannels and electrodes of the flexible microfluidic device are configured to carry out cell separation, DNA sequencing, enzyme/substrate reaction systems, biosensing, implanted drug delivery or metabolite analysis.

6. A flexible microfluidic device, comprising:
a first substrate having micro-rough channels formed in a first surface thereof; and
a second substrate having conductive electrodes disposed on a second surface thereof, wherein at least one of the first surface and the second surface is treated to form a treated surface, and wherein the treated surface has an increased bonding activity as compared to the treated surface before it was treated.

7. The flexible microfluidic device of claim 6, wherein:
the treated surface is treated by treating with a silane coating, treating with a solvent including alcohol, acetone, DMSO or acetonitrile, treating with an acid, treating with heat, treating with plasma energy, treating with UV, treating with ozone, or treating with corona discharge.

8. A method of manufacturing a master mold for a microfluidic device, the method comprising:
forming a microchannel mold with raised lines extending generally orthogonally from a top surface of the microchannel mold, wherein the raised lines are formed using at least one of PCB manufacturing methods and additive printing methods; and
positioning the microchannel mold within a mold cavity.

9. A method of manufacturing a microfluidic device, the method comprising:
forming a microchannel mold having a bottom surface and a top surface, and having raised lines extending generally orthogonally from the top surface;
positioning the microchannel mold within a mold cavity of a block, with the bottom surface of the microchannel mold supported by the block, to create a master mold;
adding a first substrate material to the master mold and curing the first substrate material to form a first substrate having a first surface with microchannels formed therein;
printing electrodes on a second surface of a second substrate;
applying a bonding layer to at least one of the first surface of the first substrate and the second surface of the second substrate;
positioning the first substrate and the second substrate to align the electrodes with the microchannels with the bonding layer between the first substrate and the second substrate; and
curing the bonding layer.

10. The method of claim 9, wherein:
the raised lines of the microchannel mold are formed using PCB manufacturing methods.

11. The method of claim 9, wherein:
the raised lines of the microchannel mold are formed using additive printing methods.

12. The method of claim 9, wherein:
the first substrate material is a polymeric material chosen from polydimethylsiloxane, polymethylmethacrylate, polycarbonate, polyepoxide, cyclic olefin polymer, or cyclic olefin copolymer, and wherein the substrate material is added to the master mold in a flowable state.

13. The method of claim 9, wherein:
the electrodes are printed on the second surface of the second substrate using conductive ink.

14. The method of claim 9, further comprising:
filling the microchannels with a removable material; and
applying the bonding layer to the first surface of the first substrate over the filled microchannels.

15. The method of claim 9, further comprising:
masking the electrodes: and
applying the bonding layer to the second surface of the second substrate over the masked electrodes.

16. A method of manufacturing a microfluidic device, the method comprising:
forming a microchannel mold having a bottom surface and a top surface, and having raised lines extending generally orthogonally from the top surface;
positioning the microchannel mold within a mold cavity of a block, with the bottom surface of the microchannel mold supported by the block, to create a master mold;
adding a first substrate material to the master mold and curing the first substrate material to form a first substrate with microchannels formed in a first surface thereof;
printing electrodes on a second surface of a second substrate;
treating at least one of the first surface of the first substrate and the second surface of the second substrate to increase bonding activity;
aligning the microchannels of the first substrate and the electrodes of the second substrate; and
allowing the first surface to bond with the second surface.

17. The method of claim 16, wherein:
the raised lines of the microchannel mold are formed using PCB manufacturing methods.

18. The method of claim 16, wherein:
the raised lines of the microchannel mold are formed using additive printing methods.

19. The method of claim 16, wherein: treating the at least one of the first surface of the first substrate and the second surface of the second substrate includes treating the at least one surface with a silane coating, a solvent, an acid, heat, plasma energy, UV, ozone, or corona discharge.

20. The method of claim 19, wherein:
the at least one of the first surface of the first substrate and the second surface of the second substrate is treated with corona discharge by passing a corona discharge device over the at least one of the first surface of the first substrate and the second surface of the second substrate to activate the at least one of the first surface of the first substrate and the second surface of the second substrate for bonding.
